(19) United States
(12) Patent Application Publication
(10) Pub. No.: US 2007/0198420 A1
(43) Pub. Date: Aug. 23, 2007

(54) Method and a system for outbound content security in computer networks

(76) Inventor: Leonid Goldstein, Costa Mesa, CA (US)

Correspondence Address: J.D. HARRIMAN II, ESQ.;DLA PIPER US LLP, SUITE 400, 1999 AVENUE OF THE STARS, LOS ANGELES, CA, 90067-6023, US

(21) Appl. No.: 11/347,463

(22) Filed: Feb. 3, 2006

(51) Int. Cl. H04L 9/00

(52) U.S. Cl. 705/52

(57) ABSTRACT

The present invention relates to a method and a system for protecting data in a computer network. A device is placed on a network edge in such a way, that all outgoing data has to pass through it. Separately, a set of data that is not allowed to leave the network is defined and stored in a secure form (typically, one way hash). The device determines the network protocol, file types, transforms and normalizes the passing data, and seeks the presence of the data from the defined set. If a threshold amount of the protected data is present, the device interrupts the connection or takes another appropriate action.

### BACKGROUND OF THE INVENTION

1Field of the Invention

The present invention relates to the field of the computer network security.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all rights whatsoever.

2. Background Art

Security is an important concern in computer networks. Networks are protected from illegal entry via security measures such as firewalls, passwords, dongles, physical keys, isolation, biometrics, and other measures. FIG. 1 illustrates an example of prior art security in a network configuration. A Protective Device 102 resides between an Internal Network 101 and an Outside Network 103. There are multiple methods of protection, designed to protect the inside network (or a single computer) from entering of harmful data from the outside network. One type of the security devices is a content filtering device. It works by cataloguing allowed and banned URLs, web sites, web domains or through real time scan for forbidden words or through blocking certain IP addresses and ports. Another is a network edge anti virus device. The example of FIG. 1 is typical of prior art security schemes in that it is principally designed to limit entry to the network. However, there are fewer methods to prevent exits from a protected network in the form of data leaks. This is unfortunate, because a significant threat in networking is the leaking of confidential materials out of the network.

One method of protection includes recognizing predefined keywords in the outbound data, frequently entered manually. The security breach is determined, when a particular combination of keywords is encountered in the passing data. For example, a company, fearing leaks of its financial data, may enter keywords “revenue”, “profit”, “debt” etc. This method suffers from a high level of false positives.

Another possible method is recognizing simple patterns, such as a 16-digit credit card numbers. When such identifiers are recognized and when such outbound data has not been authorized, the data transmission may be stopped. This method suffers from high level of false positives too.

One may think that it is possible to improve the method above by comparing with actual data (i.e. actual credit card numbers in the example above), but storing actual sensitive data in the proximity of the network edge constitutes unacceptable risk in itself. Also, this system would not scale very well.

A separate problem, not addressed in the prior art, is data, converted from plain text (ASCII) into different file formats or compressed.

These prior art methods are inadequate for the task of providing security against data leakage.

### SUMMARY OF THE INVENTION

The present invention relates to a method and a system for protecting data in a computer network. A device is placed on a network edge in such a way, that all outgoing data has to pass through it. Separately, a set of data that is not allowed to leave the network is defined and stored in a secure form (typically, one way hash). The device determines the network protocol, file types, transforms and normalizes the passing data, and seeks the presence of the data from the defined set. If a threshold amount of the protected data is present, the device interrupts the connection or takes another appropriate action. Protected data may be structured or unstructured.

### BRIEF DESCRIPTION OF THE DRAWING

FIG. 1 illustrates a prior art network system.

FIG. 2 illustrates a network system according to the invention.

FIG. 3 illustrates an Inspection Device according to the invention.

FIG. 4 illustrates a structured data matching subsystem according to the invention.

FIG. 5 is a flow diagram illustrating the operation of an Inspection Device according to the invention.

### DETAILED DESCRIPTION OF THE INVENTION

In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

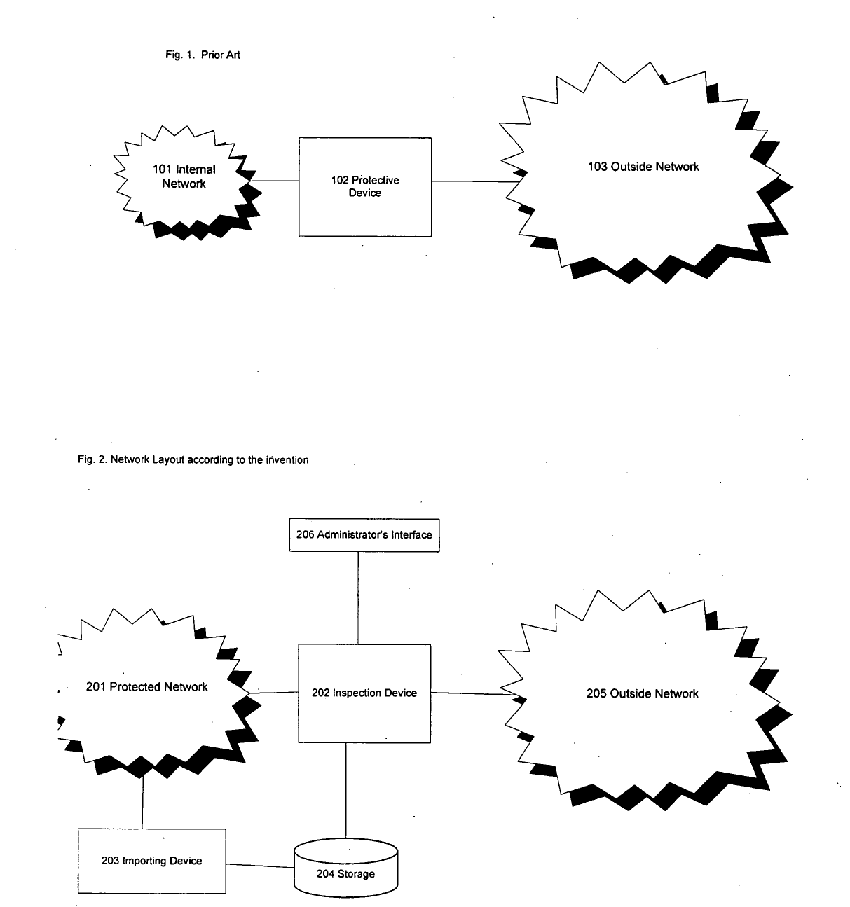

FIG. 2 illustrates a network configuration according to the invention. An Inspection Device 202 is connected to a Protected Network 201 in such a way that all the outbound traffic from the Protected Network 201 to the Outside Network 205 passes through it. An Importing Device 203 is connected to the Protected Network 201 as well, and a Storage Device 204 is set up in such a way that it is connected to both Inspection Device 202 and Importing Device 203.

The Inspection Device 202 typically comprises a computer or other networking device, with a CPU, RAM and networking means. Nevertheless, the Inspection Device 202 may comprise multiple physical devices. For example, it may comprise a Layer 4 switch and a computer connected to it.

The Importing Device 203 may comprise a stand alone computer or other networking device with a CPU, RAM. The Importing Device 203 and the Inspection Device 202 may be combined into one physical device.

Storage device 204 may be a stand alone device in the network or be combined with the Inspection Device 202 and/or the Importing Device 203. The Storage device 204 may comprise a relational database, such as MySQL or Oracle. An Administrator's Interface 206 is connected to the Inspection Device 202 for the purpose of monitoring and managing it.

FIG. 2 shows “inline” deployment, which is preferable. The Inspection Device 202 may be deployed “out of the line”, being connected to a hub or switch, so it can listen to all the network packets passing through.

Inspection Device Description

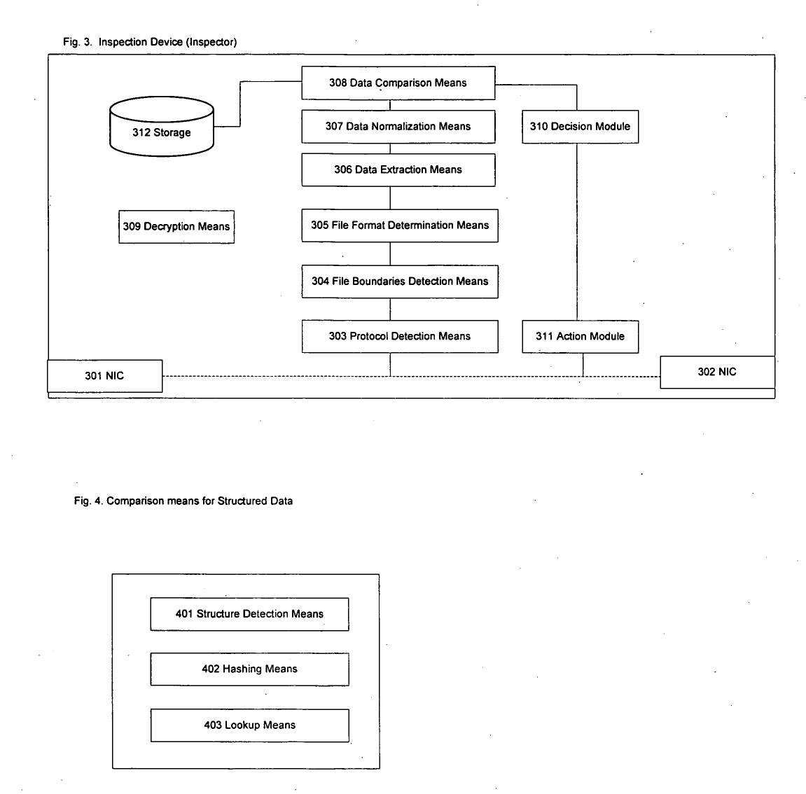

To perform it functions, the Inspection Device 202 comprises the following elements (see FIG. 3):

Network Interface (NIC) 301, connected to the network in the “inside” direction; Network Interface (NIC) 302, connected to the network in the “outside” direction; a stack of the software modules for analysis and ultimate data extraction, comprising:
Protocol Detection Means (PDM) 303
File Boundaries Detection Means (FBDM) 304
File Format Determination Means (FFDM) 305
Data Extraction Means (DEM) 306
Data Normalization Means (DNM) 307
Data Comparison Means (DCM) 308;
   and Decryption Means 309, Decision Module 310 and Action Module 311. Also, FIG. 3 shows Data Storage 312, which belongs to the Storage Device 204.

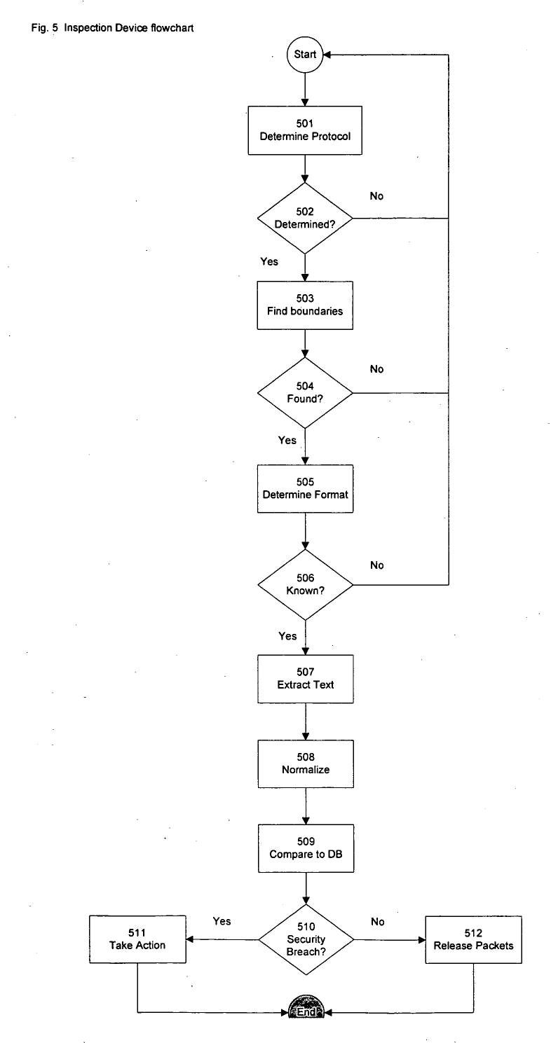

Referring to FIG. 4, DCM 308 comprises Structure Detection Means 401, Hashing Means 402, Lookup Means 403.

Importing Device operation

The function of the Importing Device 203 is to import the data that needs to be protected, process it and to store the results of this processing in the Data Storage 204. In one embodiment of the invention the data being imported is structured data. By definition, structured data has structure, which can be used to find it in an arbitrary data stream. Examples of structured data: credit card numbers, social security numbers, phone numbers, bank account numbers, driver license numbers. Structured data is typically imported from databases, spreadsheets etc. On the request from an Administrator, the Importing Device 203 imports the data that needs protection into the Storage device 2004. This data is highly sensitive, and it will be hardly acceptable to make a copy of it outside of the original location, so the importing includes a step of one way hashing, performed on each element of data. The hashing is done using MD5 algorithm, well known in the industry. Prior to the hashing, each data record may be optionally normalized, or brought into some canonical form. For example, US phone numbers may be stored in any of the following forms: ‘(xxx) xxx xxxx’, ‘+1 xxx xxx xxxx’ or ‘xxxxxxxxxx’. After normalization, all of them are brought into a form ‘xxxxxxxxxx’. In another embodiment, the data is unstructured and consists of the text or binary data.

The Importing Device 203 may operate manually or automatically. In the automatic mode, the Importing Device would periodically and re-import new database records when they change or being added. Each record may carry additional attributes, such as secrecy level, IP addresses and protocols that control its ability to be exported, etc.

Inspection Device operation

The function of the Inspection Device 202 is to monitor the outbound traffic for the presence of the protected data. It does that using the Data Storage 204. If the amount of the protected data, being transferred in a stream exceeds a predetermined threshold (for example, a combination of a social security and a credit card numbers from the same record are transferred), a security breach is declared and a predefined action is taken by the Inspection Device 202. Among the possible actions:
log the security breach;
alert security personnel;
stop the transmission of the breaching stream;
shut down the traffic between the protected network and outside world; or
any a combination of the above.

If the threshold amount of the protected data is not detected, the Inspection Device 202 allows the inspected data to be sent to the Outside Network 205.

Ideally, the Inspection Device 202 should recognize the protected data at any location in the data stream, even if the data was converted or modified. Thus, the Inspection Device 202 serves as a network bridge, where the data passing between the NIC 301 and NIC 302, is analyzed in real time. After receiving each packet, the following sequence of operations is performed (see FIG. 5):

If the packet belongs to a new TCP stream, or if the protocol is not determined, attempt to determine the protocol (step 501), using PDM 303. If not successful (check 502), wait for another packet. Examples of protocols are HTTP, FTP, SMTP, POP3, Jabber. If no supported protocol fits, the stream is declared as UNKNOWN_PROTOCOL. The descriptions of the protocols are widely available. For example, HTTP is described in RFC 2616. If successful, try to find boundaries (beginning and end) of data entities, carried by protocols (step 503), using FBDM 304. For example, SMTP (e-mail protocol), carries its body, and optionally attached files. If unsuccessful in determining beginning of the file (check 504), wait for more packets. If successful, try to determine the file format (step 505), using FFDM 305. In case of UNKNOWN_PROTOCOL, the beginning of the stream is considered as beginning of the file. If the file belongs to a known format (check 506), convert it and extract the text data in the ASCII form (step 507), using DEM 306. The methods of the text extraction depend on the specific data format. For example, for HTML files, he HTML tags should be removed. If the file format is unknown, leave it as it is. Finally, normalize output from the previous step (in step 508). Normalization brings data to some canonical form. For example, it may comprise removal non-ASCII or non-alphanumeric characters, converting upper case characters to lower case etc. Normalization is optional. Notice, that normalization here may be different from normalization, performed by Importing Device 203. Finally, compare the output of the previous step to the protected data in the Database 312 (step 509), using DCM 308.

In the preferred embodiment, the protected data comprises a set of hashes of structured data pieces, such as credit card numbers. In order to find out, whether the inspected data contains any of the protected data, perform the following steps on the inspected data: find the data with the correspondent structure. For example, in case of Visa or MasterCard numbers, consider sequences of 16 digits, starting with ‘4’ or ‘5’ and ending with a checksum. When such a sequence is detected, compute MD5 hash on it, and search in the Storage 312. It is important to use the prior knowledge of the structure of the data to its fullest, because a database query is an expensive operation and its use should be minimal. If a match is found, then there is an attempt to send the credit card number outside. In the check 510, the Decision Module 310 decides, whether a security breach has occurred. In the preferred embodiment, each attempt to send outside protected data will be considered a security breach. In another preferred embodiment, the system administrator will specify, how many pieces of protected data are allowed out, before the security breach is declared. Further, this threshold may differ depending on the identity of the sender, receiver or sending method. For example, a customer service rep will be allowed to send one credit card number to a partner, while the supervisor can send five numbers.

Finally, if there is a security breach, a command is issued to the Action Module 311 (step 511), and it blocks the data stream, sends an email to the Administrator and/or takes other actions. If there is no security breach, the packets, corresponding to the inspected data, are released (step 512). If the incoming data can not be inspected for some pre-defined time (200 ms in preferred embodiment), the packets are released anyway to prevent TCP stream disconnect.

The embodiment, described above, allows multiple modifications. The data may be transferred through an encrypted networking protocol, such as SSL. In this case, before step 503 or step 501, a step of decryption may be added, if the encryption key is known (i.e. entered by the administrator). Independent of the network protocol encryption, some transmitted files may be encrypted too. In this case, step 507 of converting and extracting should comprise an operation of decrypting the file, if the key is known. Decryption Means 309 are used.

Other examples of the structured data are bank account numbers, social security numbers, state driving licenses, phone numbers etc. The protected data may comprise arbitrary textual information, rather than structured data. The search methods for textual information are well known in the art. The protected data may be binary as well. The protected data may be stored in the memory of the Inspection Device 202, rather than in the database.

I claim:

1. A system for controlling data transfers from a protected internal network to an unprotected outside network comprising:
an inspection device coupled to said network to monitor all transmissions out of said internal network, said inspection device comprising:
means for identifying file boundaries in the transmitted data,
means for determining format of said files,
means for extracting data of interest from said files,
means for comparing said data of interest with pre-defined data,
means for blocking data transmission, if a threshold amount of said data of interest matches pre-defined data
